(19) United States
(12) Patent Application Publication
(10) Pub. No.: US 2026/0075438 A1
(43) Pub. Date: Mar. 12, 2026

(54) SYSTEM AND METHOD FOR A DEPLOYABLE MESH WIRELESS NETWORK

(71) Applicant: Alexander Socransky, Los Angeles, CA (US)

(72) Inventor: Alexander Socransky, Los Angeles, CA (US)

(21) Appl. No.: 19/305,720

(22) Filed: Aug. 20, 2025

Related U.S. Application Data
(60) Provisional application No. 63/685,647, filed on Aug. 21, 2024.

(51) Int. Cl. H04W 16/24; H04K 3/00; H04W 12/037; H04W 24/04; H04W 76/10

(52) U.S. Cl. CPC H04W 16/24; H04K 3/224; H04W 12/037; H04W 24/04; H04W 76/10

(57) ABSTRACT

Disclosed herein is a system and method for a mesh wireless network, deployable via an aircraft, drone, or other airborne system. Wide area network (WAN) connectivity is provided via a backhaul interface selected from a modem, satellite transceiver, wired module, or other wireless interface. Nodes are powered internally by portable supplies such as batteries, solar, wind, or kinetic energy, enabling continuous operation. The system enables rapid deployment in conflict zones, disaster areas, maritime or remote searches, and mass casualty events, with uninterrupted connectivity even when nodes are damaged or lost. Each node is portable, durable, and water-resistant, with housing comprised of resilient materials to withstand explosions, ammunition, and extreme weather. Multiple nodes form a mesh Wi-Fi network, with traffic routable via any node connected to a backhaul channel. Each node includes a processor for routing and inter-node communication. Nodes may also implement encryption, anti-jamming, and overlapping densities to maintain connectivity.

### CROSS REFERENCE TO RELATED APPLICATIONS

This application claims the benefit of U.S. Provisional Patent Application Number 63/685,647, filed Aug. 21, 2024, the contents of which are incorporated herein by reference.

### BACKGROUND OF THE INVENTION

The present invention is directed to a Wi-Fi mesh network. A Wi-Fi mesh network is a type of wireless network system designed to provide consistent Wi-Fi coverage across a large area. Unlike a traditional router-based network, which relies on a single router to broadcast a signal, a mesh network uses multiple devices, known as nodes or mesh points, to create a unified network. There exists a need for a mesh wireless networking system to be immediately deployable in real-time over an area where communication is needed and where conventional communication is impractical, such as a battlefield, maritime, emergency or disaster zone where public utilities have been halted or are currently unavailable.

### SUMMARY OF THE INVENTION

The present invention pertains to a system and method for a deployable mesh wireless network. The present invention consists of one or more mesh nodes, also referred to routers or mesh access points, each comprising a wireless transceiver, a processor, and a backhaul interface selected from a modem, satellite transceiver, wired module, or other wireless wide area network interface. Each node includes a processor configured to route data packets and to communicate with one or more other nodes, including any node connected to a backhaul channel, thereby avoiding reliance on a single central node. This allows the mesh network to become stronger and less susceptible to jamming, while increasing available bandwidth and maintaining network functionality even when one or more nodes are damaged or inoperative.

Additional nodes that are deployed throughout an area can wirelessly communicate with peer nodes and with each other to distribute network connectivity evenly. Seamless roaming allows client devices to automatically connect to the closest node with the strongest signal, providing uninterrupted coverage without drops or the need to manually switch networks.

In accordance with the preferred embodiment of the present invention, an aircraft, drone, or other airborne system may deposit nodes which incorporate the present invention where communication is to be established. Wide area network (WAN) connectivity can be deployed with nodes powered internally by portable power supplies such as batteries, solar power, wind generation and kinetic energy, allowing for continuous electrical generation. In this way, rapid deployment over a wide area network is possible for the first time. This would be especially useful in conflict zones, environmental disasters, maritime or remote search areas, and mass casualty events. The present invention allows for continuous signal connectivity even when one or more nodes are damaged and become inoperable.

The present invention uses portable, durable and water-resistant housing for the nodes that can withstand impact so that they may be deployed from an aircraft, drone, or other airborne system. The housing is constructed from protective, resilient material configured to withstand harsh environmental conditions and destructive forces such as an explosion, ammunition, and extreme weather events. Multiple nodes can be deployed in an area in order to create a mesh Wi-Fi network. These nodes can also implement signal encryption and anti-signal jamming capabilities, and may be deployed in densities that provide overlapping coverage to maintain connectivity in contested or jamming environments.

In another embodiment, the present invention consists of a mobile ad-hoc network (MANET), whereby no communication infrastructure is required. A MANET is a decentralized type of wireless network that consists of mobile devices (such as smartphones, laptops, or sensors) that communicate with each other directly without relying on any pre-existing infrastructure, such as routers or access points. Each device in a MANET acts as both a host to send and receive data and a router to forward data to other devices, allowing the network to dynamically reconfigure as devices move. MANETs are self-configuring and do not require any fixed infrastructure like a traditional network. Devices can join or leave the network freely. Since devices are mobile, the network topology changes frequently as devices move around. The connections between devices are constantly updating. There is no central authority or control over the network. Every device in the network is responsible for forwarding data, making routing more complex. Devices communicate directly with each other, often using multi-hop routing, where data is relayed through several devices before reaching its destination. The communication range can be typically limited by the capabilities of the mobile devices, so the network relies on nodes being able to forward data to extend coverage.

The mobile nodes also play the role of the routers, helping to forward data packets to their destinations via multiple-hop relay. This type of network is suitable for situations where a fixed infrastructure is unavailable or infeasible, and is a cost effective solution since the same ad-hoc network can be relocated, and reused in different places at different times for different applications. MANETs can be used in battlefield environments where infrastructure is not available, allowing soldiers to communicate in remote areas. After natural disasters, MANETs can be quickly deployed for communication when regular infrastructure has been destroyed, and used in environmental monitoring where devices need to communicate over large areas without fixed infrastructure.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is a diagram of a wireless mesh network environment of the present invention.

FIGS. 2A-C are overviews of an autonomous mesh mobile network of the present invention.

FIG. 3 is a diagram of the present invention.

### DETAILED DESCRIPTION OF THE PREFERRED EMBODIMENT

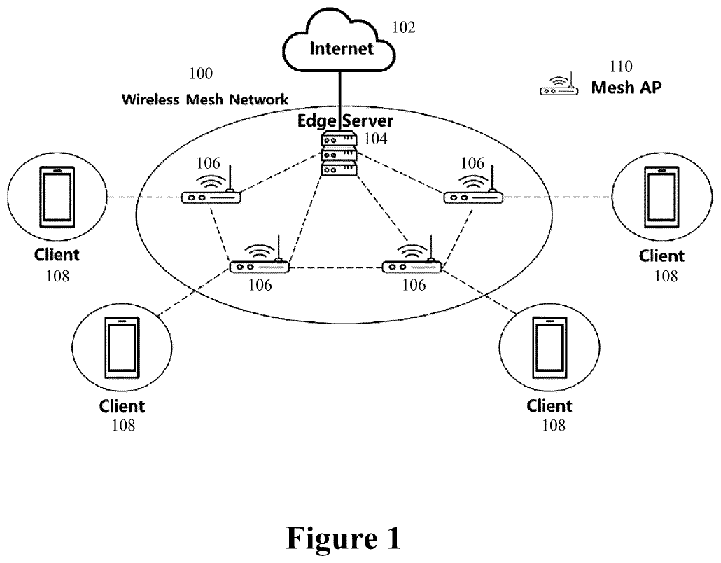

FIG. 1 is a diagram of a wireless mesh network environment of the present invention. In accordance with the preferred embodiment of the present invention, a wireless mesh network environment 100 consists of an internet signal 102, connected to a server 104, which can wirelessly transmit the signal to a network of nodes 106. These nodes 106 form a wireless mesh network 100 that can cover a specific area, allowing for the wireless client 108 and mesh access point 110 to connect to the network 100.

In accordance with the preferred embodiment, the present invention consists of one or more nodes connected to a backhaul channel (e.g., modem, satellite transceiver, wired module, or wireless WAN interface). Other nodes route through them to maintain functionality without reliance on a single central hub. Additional nodes can be deployed throughout an area and communicate with each other to distribute connectivity evenly across the mesh Wi-Fi network. Seamless roaming allows client devices to automatically connect to the closest node with the strongest signal, providing uninterrupted connectivity without drops or the need to manually switch networks.

In accordance with the preferred embodiment of the present invention, an aircraft, drone, or other airborne system may deposit nodes which incorporate the present invention where communication is to be established. Wide area network (WAN) coverage can be deployed with nodes powered internally by portable power supplies such as batteries, solar power, wind generation and kinetic energy, allowing for continuous electrical generation. In this way, rapid deployment over a wide area network is possible for the first time. This would be especially useful in conflict zones, environmental disasters, maritime or remote search areas, and mass casualty events. The present invention allows for continuous signal connectivity even when one or more nodes are damaged and become inoperable.

The present invention uses portable, durable and water-resistant housing for nodes that can withstand impact so that they may be deployed from an aircraft, drone, or other airborne system. The housing is constructed from protective, resilient material configured to withstand harsh environmental conditions and destructive forces such as an explosion, ammunition, and extreme weather events. Multiple nodes can be deployed in an area in order to create a mesh Wi-Fi network. These nodes can also implement signal encryption and anti-signal jamming capabilities.

In another embodiment, the present invention consists of a mobile ad-hoc network (MANET), whereby no communication infrastructure is required. A MANET is a decentralized type of wireless network that consists of mobile devices (such as smartphones, laptops, or sensors) that communicate with each other directly without relying on any pre-existing infrastructure, such as routers or access points. Each device in a MANET acts as both a host to send and receive data and a router to forward data to other devices, allowing the network to dynamically reconfigure as devices move. MANETs are self-configuring and do not require any fixed infrastructure like a traditional network. Devices can join or leave the network freely. Since devices are mobile, the network topology changes frequently as devices move around. The connections between devices are constantly updating. There is no central authority or control over the network. Every device in the network is responsible for forwarding data, making routing more complex. Devices communicate directly with each other, often using multi-hop routing, where data is relayed through several devices before reaching its destination. The communication range can be typically limited by the capabilities of the mobile devices, so the network relies on nodes being able to forward data to extend coverage.

The mobile nodes also play the role of the routers, helping to forward data packets to their destinations via multiple-hop relay. This type of network is suitable for situations where a fixed infrastructure is unavailable or infeasible, and is a cost effective solution since the same ad-hoc network can be relocated, and reused in different places at different times for different applications. MANETs can be used in battlefield environments where infrastructure is not available, allowing soldiers to communicate in remote areas. After natural disasters, MANETs can be quickly deployed for communication when regular infrastructure has been destroyed, and used in environmental monitoring where devices need to communicate over large areas without fixed infrastructure.

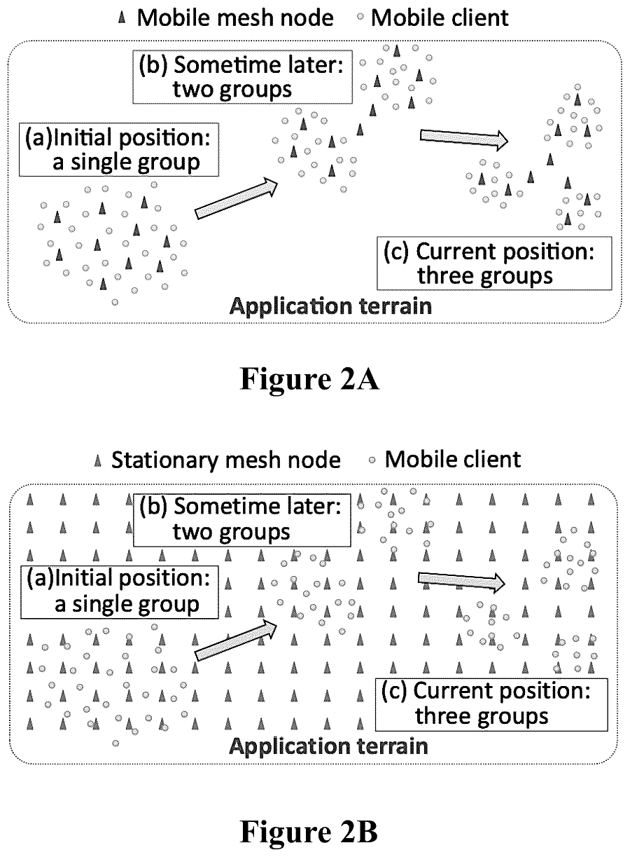

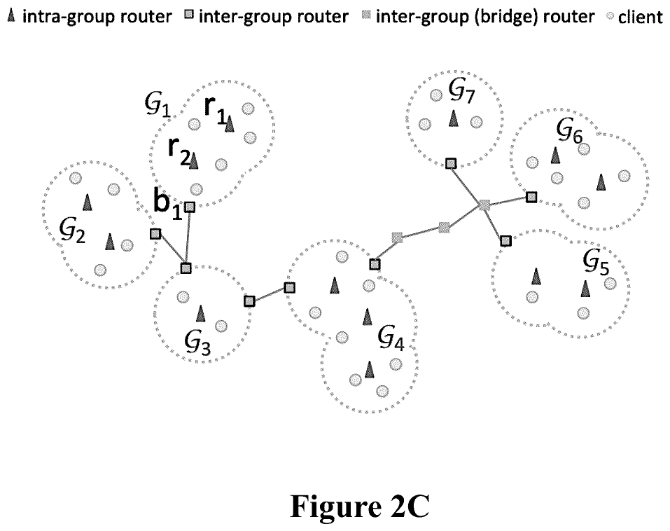

FIGS. 2A-C are overviews of an autonomous mesh mobile network of the present invention. In accordance with the preferred embodiment of the present invention, FIG. 2A is an overview of the autonomous mobile mesh network under three scenarios over an application terrain. The mesh clients initially concentrate in one group. All the mesh nodes position themselves within the same proximity to support communications inside the group. The mesh clients move northwards and split into two groups. The mobile mesh nodes, in this case, reorganize themselves into a new topology not only to facilitate intra-group communications, but also to support inter-group communications effectively preventing a network partition. The same mesh clients now move southeast and form three groups. The mobile mesh nodes adapt their topology accordingly to achieve full connectivity for all the mesh clients.

FIG. 2B is a fixed grid-based square topology under three scenarios illustrated in FIG. 2A, which can provide coverage for an entire application terrain. FIG. 2C shows an overview of an autonomous mesh mobile network, where the routers are partitioned into two groups. As used herein, the term ‘router’ is used to describe those nodes that perform routing functions within the mesh. Intra-group routers support intra-group communication; and inter-group routers prevent a network partition. A mesh node is an intra-group router if it detects at least one client within its radio range and is in charge of monitoring the movement of clients in its range. Intra-group routers that monitor the same group of clients can communicate with each other via multi-hop routing. A mesh node is an inter-group router, i.e., if it plays the role of a relay node helping to interconnect different groups. A mesh node is a free router if it is neither an intra-group router nor an inter-group router.

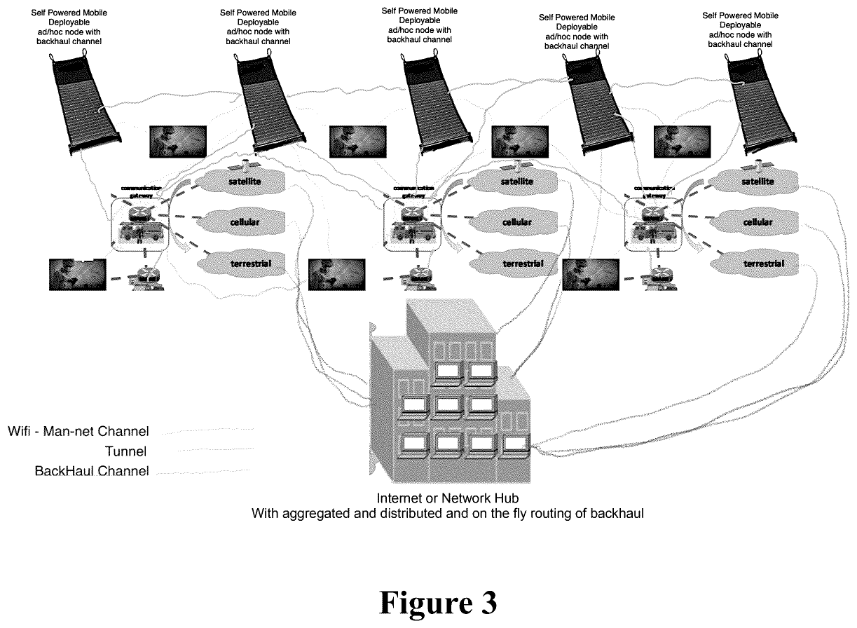

FIG. 3 is a diagram of the present invention. In accordance with the preferred embodiment, the present invention is comprised of an internet or network hub with aggregated, distributed and on the fly routing of backhaul. The backhaul is an intermediate link between the core network and the edge of the network, where the end-users connect, carrying data from local access points (like cell towers, local internet service providers, or Wi-Fi access points) back to the core of the internet. Backhaul can involve various technologies and transmission methods, such as fiber optic cables, microwave and satellite links. The internet or network hub is connected by way of internet tunnels to terrestrial, cellular or satellite signal transmitters. A tunnel connection refers to a secure connection made over the internet between two or more devices or networks. A tunnel is used because it encapsulates or wraps the data in an encrypted manner, making it look like it's traveling through a private tunnel, despite moving over a public internet network. The data inside the tunnel is encrypted, which means that it is scrambled and protected from unauthorized access. Internet tunnels are often used to securely connect users to remote networks, ensuring that the data exchange is protected from cyber threats. The signal transmitters relay the signal to a communication gateway, which can provide a signal to multiple nodes. A backhaul channel connects the communication gateway to a self-powered mobile deployable ad/hoc node. The node transmits a Wi-Fi signal through a wireless man-net channel in any area. The node can wirelessly connect to other nodes in the same area to create a secure and reliable wireless mesh network.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A deployable mesh wireless network system comprising:
a node configured to connect to a backhaul channel selected from the group consisting of a modem, satellite transceiver, wired module, or other wireless wide area network interface;
a plurality of portable mesh nodes configured to wirelessly communicate with one another to form a unified wireless mesh network;
each of said plurality of portable mesh nodes comprising a self-contained power source selected from the group consisting of batteries, solar power, wind generation, and kinetic energy generation;
an impact-resistant, water-resistant housing for each said mesh node, said housing configured to withstand destructive forces;
a wireless transceiver configured for mesh network communications;
a processor configured to route data packets and to communicate with one or more other nodes including any node connected to a backhaul channel;
a roaming capability configured to automatically connect wireless client devices to a nearest mesh node having strongest signal strength without manual switching;
an encryption capability and an anti-signal jamming capability configured to secure data transmissions and reduce disruption of the wireless mesh network;
a routing capability configured to reroute network traffic when one or more mesh nodes become damaged or inoperative; and
an aerial deployment capability configured to enable release of said plurality of portable mesh nodes from an aerial vehicle or other airborne system selected from the group consisting of a drone and an aircraft for establishment of network coverage over a target area.

2. The system of claim 1 wherein said mesh network is a mobile ad-hoc network (MANET) wherein each mesh node operates as both a host and a router to enable direct communication without fixed infrastructure.

3. The system of claim 1 wherein said plurality of portable mesh nodes support multi-hop routing of data to extend coverage beyond range of individual nodes.

4. The system of claim 1 wherein said backhaul channel is configured for aggregated, distributed, and dynamic routing to increase bandwidth and network resilience.

5. The system of claim 1 wherein at least one mesh node is configured as an intra-group router for localized communications within a group of wireless clients, and at least one mesh node is configured as an inter-group router for maintaining connectivity between separate groups.

6. The system of claim 1 wherein said plurality of portable mesh nodes are configured for deployment in a quantity and spacing sufficient to generate an overlapping network coverage area, thereby establishing a prevailing aggregate signal strength across a contested environment to mitigate adversarial jamming.

7. A method for deploying a mesh wireless network comprising:
establishing a node connected to a backhaul channel selected from the group consisting of a modem, satellite transceiver, wired module, or other wireless wide area network interface;
deploying a plurality of portable mesh nodes over a target area, each of said mesh nodes comprising an impact-resistant and water-resistant housing, a wireless transceiver configured for mesh network communications, and a processor configured to route data packets and to communicate with one or more other nodes including any node connected to a backhaul channel;
activating said plurality of portable mesh nodes to wirelessly communicate with one another to form a unified wireless mesh network;
automatically connecting wireless client devices to a nearest mesh node having strongest signal strength;
maintaining network connectivity by rerouting traffic when one or more mesh nodes become damaged or inoperative;
securing data transmissions using encryption and reducing disruption using anti-signal jamming; and
deploying said plurality of portable mesh nodes from an aerial vehicle or other airborne system selected from the group consisting of a drone and an aircraft.

8. The method of claim 7 wherein each mesh node operates as both a host and a router in a mobile ad-hoc network.

9. The method of claim 7 further comprising routing data using multi-hop communications between said plurality of portable mesh nodes to extend network coverage.

10. The method of claim 7 further comprising powering each said mesh node using a self-contained power source selected from the group consisting of batteries, solar power, wind generation, and kinetic energy generation.

11. The method of claim 7 further comprising encrypting said communications and using anti-signal jamming to reduce interference.

12. The method of claim 7 wherein deploying said plurality of portable mesh nodes further comprises releasing said plurality of portable mesh nodes from a drone, aircraft, or other airborne system, each mesh node having an impact-resistant, water-resistant housing.

13. The method of claim 7 further comprising deploying said plurality of portable mesh nodes in a quantity and spacing sufficient to generate an overlapping network coverage area, thereby establishing a prevailing aggregate signal strength across a contested environment to mitigate adversarial jamming.
